(19) United States
(12) Patent Application Publication
(10) Pub. No.: US 2009/0025280 A1
(43) Pub. Date: Jan. 29, 2009

(54) METHOD OF HEAT GENERATION

(75) Inventor: Josef Tapper, Charlton (GB)

Correspondence Address: SENNIGER POWERS LLP, 100 NORTH BROADWAY, 17TH FLOOR, ST LOUIS, MO, 63102, US

(73) Assignee: THE S TAPPER COMPANY LIMITED, Charlton (GB)

(21) Appl. No.: 12/162,830

(22) PCT Filed: Jan. 30, 2007
(86) PCT No.: PCT/GB07/00307

§ 371 Date: Sep. 11, 2008

(30) Foreign Application Priority Data
Jan. 31, 2006 (GB) 0601828.7

(51) Int. Cl. C10L 1/192; B01J 19/24

(52) U.S. Cl. 44/313; 44/629

(57) ABSTRACT

A method of heat generation comprising reacting carbohydrate with a concentrated acid in a reaction vessel in an exothermic reaction, and removing the heat generated by the reaction through a heat exchange medium.

This invention relates to a method of heat generation, and in particular to a method which does not directly utilise fossil fuels.

In colder climates, heat generation for domestic and commercial buildings is typically generated by electrical or gas powered systems. Some groups of buildings or units within a large building may be linked by a centralised heating system where heat is generated at a central location and distributed via a heat exchange system typically using a fluid to carry the heat away from the site where it is generated. The heat is generated by burning fossil fuel either locally, for example in an oil-fired, gas-fired or coal-fired boiler, or at a remote location such as an electrical power station which may be oil-fired, gas-fired or coal-fired.

The burning of fossil fuels generates carbon dioxide which is largely responsible for the raising of the temperature of the Earth's atmosphere through the greenhouse effect as the percentage of carbon dioxide in the atmosphere is raised.

According to the present invention, there is provided a method of heat generation comprising
reacting carbohydrate with concentrated acid, preferably concentrated sulphuric acid, in a reaction vessel, and
removing the heat generated by the reaction through a heat exchange medium.

Preferably, the method is a substantially continuous method of heat generation.

The reaction between concentrated sulphuric acid and carbohydrate is an exothermic reaction. The concentrated acid, preferably sulphuric acid, may be contacted with the carbohydrate under suitable reaction conditions to produce water and, typically, carbon (dehydration reaction). Although elemental carbon is generally produced, heavy hydrocarbons may also be formed, depending on the carbohydrate employed.

The water produced may be removed from the reaction as steam and utilised as desired. For example, the steam may be used to drive a prime mover, such as a turbine, or may be condensed to obtain heat and water. The carbon residue formed as a result of the reaction may be removed from the reaction vessel and used or stored. For example, if amorphous carbon black is produced, it may be used as a pigment, an absorbent or as a reinforcing material.

An advantage of the present invention is that it allows energy to be produced in the substantial absence of carbon dioxide.

The reaction between concentrated acid (e.g. sulphuric acid) and carbohydrate may be carried out in any suitable manner. For example, in one embodiment, the concentrated sulphuric acid is added (e.g. continuously) to a reaction vessel containing the carbohydrate. Preferably, however, carbohydrate is added to a reaction vessel containing the acid (e.g. sulphuric acid). In one embodiment, the carbohydrate is added to the acid substantially continuously. It is also possible to feed both the carbohydrate and the acid into the reaction vessel, for example, sequentially or simultaneously.

Preferably, the concentrated acid is sulphuric acid. The sulphuric acid employed should be sufficiently concentrated to react with carbohydrate to produce water and elemental carbon. The sulphuric acid solution may have a concentration of at least 70% w/w, preferably 75% w/w to 98% w/w. In one embodiment, the sulphuric acid has a concentration of 77 to 98% w/w.

Any suitable carbohydrate may be used in the process of the present invention. The carbohydrate is preferably employed in non-aqueous form. For example, solid or molten carbohydrate may be employed. Suitable carbohydrates include starch and sugars. Sugar is preferably employed. The sugar may be derived from plants, such as sugar beet and sugar cane. In a preferred embodiment, the sugar is sucrose, fructose and/or glucose. Complex carbohydrates may also be employed. These may produce heavy hydrocarbons when reacted with the concentrated acid.

The carbohydrate (e.g. sugar) is typically obtained from plants which have absorbed carbon dioxide during their growth. Since the reaction between the sulphuric acid and sugar produces heat and substantially no carbon dioxide, the heat generation process effectively removes carbon dioxide from the atmosphere and produces carbon as a waste product. The ratio of carbohydrate to concentrated acid may be adjusted to produce heat at a desirable rate.

The heat generated by the reaction may be removed from the reaction using a heat exchange medium. The heat exchange medium may be solid or liquid. For example, the heat exchange medium is an oil based liquid that is inert to the concentrated acid (e.g. sulphuric acid), such as a silicone oil. Other suitable heat exchange media include thermoelectric cells that convert heat directly to electricity.

In one embodiment, the heat exchange medium flows around the reaction vessel. In this way, heat generated in the reaction vessel can be transferred across the walls of the reaction vessel into the heat exchange medium.

Heat from the heat exchange medium may be used to heat a fluid for driving a prime mover. Suitable fluids include water and air. In one embodiment, heat from the heat exchange medium (e.g. oil) is used to heat water to generate steam for driving a prime mover, such as a turbine. In this way, the heat generated by the reaction can be converted into mechanical energy.

The heat exchange medium may also be used as a heating fluid for a heat exchanger, such as a radiator. Alternatively or additionally, the heat exchange medium may be used to heat another fluid, which is used as a heating fluid for a heat exchanger. An example of a suitable heating fluid is water. In one embodiment, heat from the heat exchange medium (e.g. oil) is transferred to water, which is then used as a heating fluid for a heat exchanger (e.g. radiator). The system, therefore, may be used as a means for heating an enclosed space, for example, in a building or a vehicle, such as a coach, car, boat or ship.

Before reacting the concentrated acid (e.g. sulphuric acid) with the sugar, the concentrated acid (e.g. sulphuric acid) is preferably heated to an elevated temperature. Preferably, the acid is heated to above the boiling point of water at the given pressure conditions. This ensures that any water produced in the dehydration reaction boils off, reducing the risk of the acid being diluted during the course of reaction.

Suitable temperatures include temperatures above 80 degrees C., for example, at least 100 degrees C. In a preferred embodiment, the concentrated acid (e.g. sulphuric acid) is heated to 100 to 300 degrees C., preferably, 100 to 200 degrees C., more preferably 100 to 150 degrees C., even more preferably 100 to 120 degrees, for example 100 to 105 degrees C. As mentioned above, temperatures above the boiling point of water are preferred as this can help to ensure that the water generated in the reaction is vaporised as steam and the strength of the acid remains substantially constant. This heating step may be carried out in the reaction vessel, for example, by heating the reaction vessel containing the acid (e.g. sulphuric acid). Alternatively or additionally, the acid may be preheated before it is introduced into the reaction vessel. If the reaction vessel is pressurised, the acid is preferably heated to above the boiling point of water at the relevant pressure.

In one embodiment, the reaction vessel is provided with a heat exchange jacket and any heat is removed by the use of a heat exchange medium flowing through the jacket. The preferred heat exchange medium is an oil based fluid which is inert to acids, such as sulphuric acid. The heat exchange jacket may also be used to heat the acid to a temperature of about 100 to 105° C. before any carbohydrate (e.g. sugar) is added to the system. This ensures that any water generated in the reaction is vaporised as steam and the strength of the acid remains substantially constant. If pressurised reactor vessels are used, then the acid must be heated to just above the boiling point of water at that pressure.

The method may be carried out in a batch or continuous manner. Preferably, the method is a continuous process with carbohydrate (e.g. sugar) being added continually to the reaction vessel and carbon being removed from the reaction vessel. In one embodiment, the carbon is allowed to settle at the bottom of the reaction vessel as a residue. The carbon residue may then be removed from the base of the reaction vessel, for example, via an outlet.

The carbon may be treated to remove any acid (e.g. sulphuric acid) and/or water before or after it is removed from the reaction vessel. For example, after the carbon is removed, the carbon may be washed and dried using conventional techniques. Alternatively or additionally, the carbon residues may be subjected to temperature and/or pressure conditions appropriate to cause any acid (e.g. sulphuric acid) residues in the carbon to decompose. Where sulphuric acid is employed, the sulphuric acid residues may decompose to sulphur oxides (e.g. SO₂ and SO₃) and water (steam). For example, the carbon residues may be subjected to a decrease in pressure and/or an increase in temperature sufficient to cause any sulphuric acid residues to decompose to form sulphur oxides (e.g. SO₂ and SO₃) and water.

The sulphur oxides produced as a result of this decomposition reaction typically include sulphur dioxide and/or sulphur trioxide. These sulphur oxides may be reacted with water under suitable conditions to form acid. The acid produced may be returned to the reaction vessel to react with carbohydrate. In one embodiment, the sulphur oxides are recycled directly back to the reaction vessel, where they react to form concentrated sulphuric acid in situ.

Optionally, any SO₂ produced may be oxidised to SO₃ prior to the reaction with water. This oxidation reaction may be carried out in the presence of a catalyst, for example, vanadium pentoxide. Elevated temperatures of, for example, 450 degrees C. may also be employed.

Alternatively or additionally, the sulphur oxides produced as a result of the decomposition of sulphuric acid may be used in a sulphur iodine (SI) cycle. Specifically, any sulphur dioxide produced may be reacted with iodine and water according to the Bunsen reaction:

I₂+SO₂+2H₂O→HI+H₂SO₄

The sulphuric acid produced may be recycled, for example, for further decomposition or for reaction with carbohydrate.

The HI produced may be decomposed to produced hydrogen and iodine according to the reaction:

2HI→H₂+I₂

The iodine produced may be re-used in the Bunsen reaction above. The hydrogen produced may be used for a variety of applications; for example, it may be used in a fuel cell.

According to a further aspect of the invention, there is provided an apparatus for carrying out the method described above, said apparatus comprising
a reaction vessel for the reaction between concentrated acid (e.g. sulphuric acid) and carbohydrate,
means for introducing carbohydrate into the reaction vessel,
means for removing any carbon produced in the reaction from the reaction vessel, and, optionally,
means for circulating a heat exchange medium around the said reaction vessel.

The reaction vessel may be divided into two or more compartments. In one embodiment, the reaction vessel comprises a first (e.g. upper) compartment that is separated from a second (e.g. lower) compartment by a valve. By placing the valve in a closed position, the second compartment can be isolated from the first compartment, allowing the reaction in the first compartment to continue substantially continuously.

Once isolated from the first compartment, the reaction mixture or slurry in the second compartment may be subjected to a reduced pressure (and/or increased temperature). Where the acid is sulphuric acid, this reduction in pressure (and/or increase in temperature) may cause the sulphuric acid entrained in the carbon residue to decompose into steam and sulphur oxides. The sulphur oxides produced as a result of this decomposition reaction typically include sulphur dioxide and sulphur trioxide. These sulphur oxides may be reacted with water under suitable conditions to produce sulphuric acid. The sulphuric acid produced may be returned to the reaction vessel to react with carbohydrate. In one embodiment, the sulphur oxides are recycled directly back to the first compartment, where they react to form concentrated sulphuric acid in situ. In an alternative embodiment, the sulphur oxides, in particular sulphur dioxide, is reacted with iodine in the presence of water in a Bunsen reaction (see above). The sulphuric acid produced may be returned to the reaction vessel for reaction with carbohydrate. The hydrogen iodide produced in the Bunsen reaction may be decomposed to form iodine and hydrogen. Any sulphur dioxide may alternatively be oxidised to sulphur trioxide in the presence of a catalyst, such as vanadium oxide. The sulphur trioxide produced may be reacted with water to produce sulphuric acid. The sulphuric acid may be returned to the reaction vessel for reaction with carbohydrate.

Once sulphuric acid residues have been removed from the carbon, the carbon may be removed from the second component, for example, via an outlet valve. The outlet valve may then be closed and the valve between the first and second compartments opened to allow fluid communication between the first and second compartments. If necessary, the pressure in the first compartment may be reduced, for example, by venting steam into second compartment, to allow the pressure between the first and second compartments to equalise before the valve between them is opened.

The apparatus may further include one or more heat exchangers, such as radiators. The heat exchange medium may be used as a heating fluid for the heat exchanger. Accordingly, heat generated in the reaction vessel is transferred to the heat exchange medium which is then used as a heating fluid for the heat exchanger(s). When radiators are used as the heat exchangers, the heat transferred from the heat exchange medium may be used to heat an enclosed space, such as a room in a building or a vehicle. Instead of using the heat exchange medium directly as the heating fluid, it may also be possible to use the heat exchange medium may to heat a separate fluid, such as water, which is then used as a heating fluid for the heat exchanger(s).

The apparatus may also be coupled to or include a prime mover. The apparatus may also include means for transferring a fluid for driving the prime mover to the prime mover. Heat from the heat exchange medium may be used to heat the fluid for driving the prime mover. In this way, the heat generated in the reaction vessel can be converted into mechanical energy. An example of a suitable prime mover is a turbine. In one embodiment, heat from the heat exchange medium is used to heat water to produce steam. The steam produced is used to drive a turbine to produce electricity.

The invention will be described by way of example and with reference to the accompanying drawings in which:

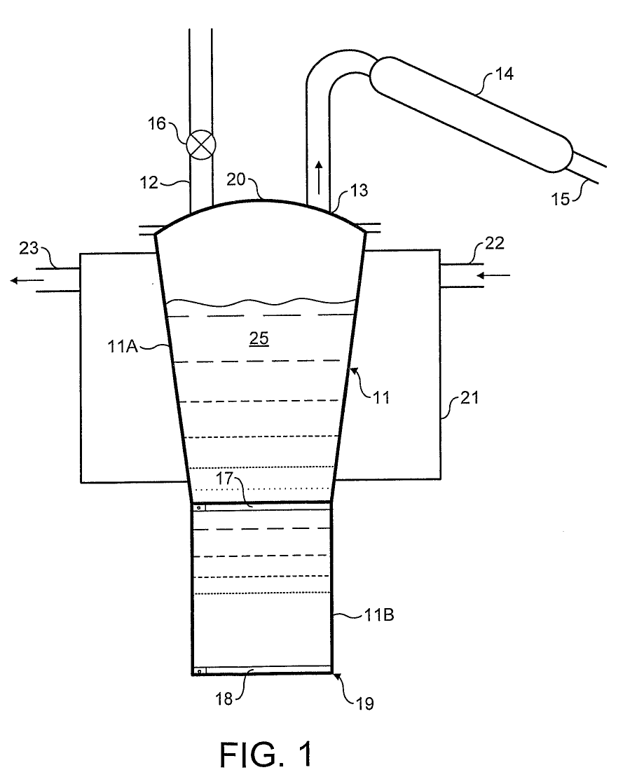

FIG. 1 is a schematic drawing of an apparatus according to a first embodiment of the present invention, and

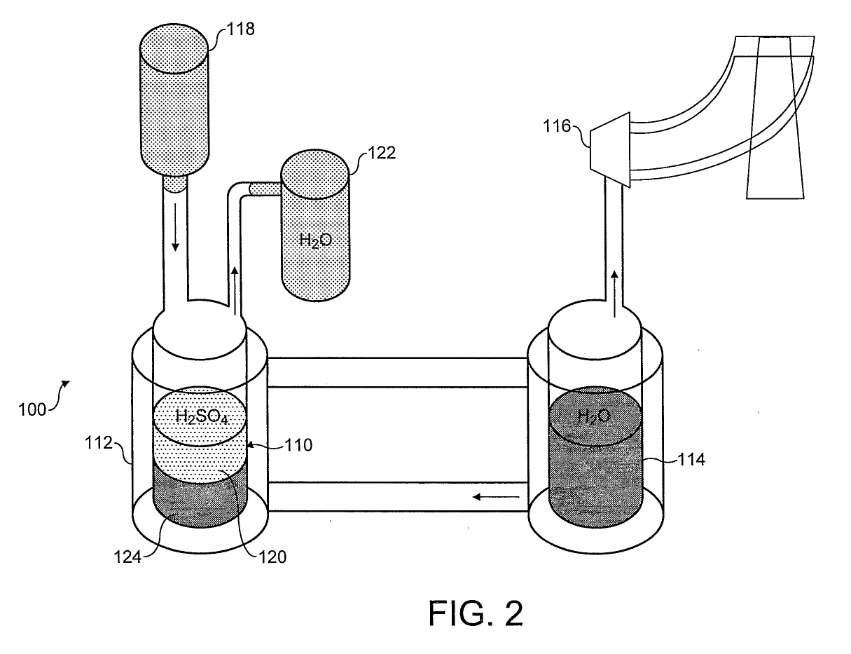

FIG. 2 is a schematic drawing of an apparatus according to a second embodiment of the present invention.

With reference to FIG. 1, there is shown a reaction vessel 11 formed from a suitable material which is resistant to sulphuric acid and elevated temperature, for example glass, porcelain, and tantalum alloy. The reaction vessel 11 has an upper portion 11A substantially in the form of an inverted hollow cone and a lower portion 11B which is substantially cylindrical. The inverted cone shape allows for a reduction in diameter towards the narrower lower portion 11B whilst preventing a build up of carbon on the sides of the vessel 11. The vessel 11 may be provided with a domed top 20 with an inlet port 12 in its upper surfaces for the addition of reactants to the vessel. The top 20 may be in the form of a removable lid. The inlet port 12 must be sufficiently high so that no acidic fumes reach the inlet port. Alternatively a suitable valve 16 mechanism may be used.

An outlet port 13 is also provided in the upper surface to allow steam from the reaction to exit the reactor vessel. The outlet port 13 may be connected to some steam operated utility, or as shown to a condenser 14 having a water outlet 15. The height of the condenser 14 must be such that no acidic fumes exit the reactor via the condenser.

The lower portion 11B of the reaction vessel 11 is provided with two shut-off valves 17 and 18 located in series. One valve 17 is located between the conical upper and cylindrical lower portions 11A and 11B of the reactor vessel and the other valve 18 is located at the reactor vessel exit port 19. Both valves are shown in a closed condition in FIG. 1.

The conical portion of the reactor vessel 11 is surrounded by a heat exchange jacket 21 having a fluid inlet 22 and a fluid outlet 23 for the flow through of a heat exchange fluid, for example an oil based fluid which is inert to sulphuric acid. Water could be used as the heat exchange medium but this is not generally desirable in view of violent reaction that can occur between concentrated sulphuric acid and water. The heat exchange jacket 21 may be part of a recirculation system and outlet 23 may be connected to further heat exchange systems.

Concentrated sulphuric acid 25 is loaded into the reactor vessel 11 through the inlet port 12, or through the open lid 20.

To start the process, the inner valve 17 is in the open position and the outer valve 18 is closed. The heat exchange fluid in the jacket 21 is preheated to about 100 to 105° C. in order to heat the sulphuric acid to about 100° C. The sugar is added through the inlet port 12. Steam from the reaction rises and exits through the steam outlet port 13 and is condensed in condenser 14 and exits as water through the water outlet 15. The condensed water may be acidic and acid may be recovered for recycling. The latent heat from the steam may be recovered through heat exchangers used in the condensation process and the heat in the waste water may also be recovered by use of heat exchangers.

The carbon produced in the reaction is denser than sulphuric acid and will sink and accumulate in the chamber between valves 17 and 18. The internal sides of the reaction vessel are sufficiently steep to prevent the accumulation of carbon inside the reaction chamber. The carbon will retain a considerable amount of heat and the cooling requirements of the heat exchange jacket 21 will need to take this into account. To remove the carbon, the valve 17 is closed and valve 18 is opened. Depending on the degree to which the carbon is compacted, some sulphuric may need to be recovered by washing the carbon and returned to the reaction chamber.

As an alternative to washing residual sulphuric acid from the carbon, it is possible to remove any entrained sulphuric acid by subjecting the carbon to a reduced pressure. For example, the valve 11B may be closed to separate the lower portion of the reaction vessel 11 from the upper portion of the reaction vessel. The lower portion of the reaction vessel (portion beneath valve 11B) may then be depressurized to cause the sulphuric acid to decompose into a gas comprising sulphur trioxide (and optionally sulphur dioxide) and steam. This gas may be recycled back to upper portion of the reactor (11) (i.e. the portion above valve 11A), where it will react to form sulphuric acid. The lower portion of the reactor vessel 11 will now contain dried carbon precipitate which can be removed by opening the valve 18. After removing the carbon, the pressure from the steam generated in the upper portion of the reactor is vented to the lower portion of the reactor instead of out of the system until the pressure is equalized. At this point the valve (17) may be opened to take a new charge.

Water produced as a result of the reaction between sugar and concentrated sulphuric acid is removed from the reaction vessel as steam. Accordingly, the concentration of the sulphuric acid will remain substantially constant.

The excess heat of the reaction is absorbed by the fluid in the heat exchange jacket and is removed through the outlet 23. The removed heat may be utilised as desired, for example it may be utilised to heat buildings.

As the boiling point of the sulphuric acid is approximately 330 degrees C. (depending on the real average concentration while working), the heat exchange fluid in the jacket 21 may be pressurized depending upon its boiling point. For example if water was used as the heat exchange medium then water can be pressurised easily to approximately 44 bar, without pressurising the internal chamber of the reactor vessel.

Pressurising the internal chamber of the reactor vessel 11 may require pressurised venting and injection of the sugar and steam. Furthermore pressurising the internal chamber may require using some of the excess heat to melt the sugar to liquid state and to inject it into the chamber.

Pressurizing the reactor vessel 11 may also require a finer control of the sugar flow, increased surface area of the sugar and may introduce a greater efficiency over all.

An internal pressure 3 bar within the reaction vessel raise the boiling point of the acid and water within the vessel to allow the apparatus to generate high enough temperatures within a pressurised water filled heat exchange jacket to develop working steam pressures sufficient to run standard high pressure generators.

Reference is now made to FIG. 2 of the drawings. The Figure is a schematic drawing showing an apparatus 100 in accordance with a second embodiment of the invention. The apparatus includes a reaction vessel 110, a heat exchange medium 112, a fluid (water) 114 for driving a turbine 116 and a source of sugar 118. The reaction vessel 110 contains concentrated sulphuric acid 120.

In use, sugar 118 is introduced into the reaction vessel 110. The sugar reacts with the concentrated sulphuric acid 120 in the reaction vessel 110 to produce steam and carbon. The steam may be removed from the reaction vessel and condensed in condenser 122. The carbon 124 accumulates in the reaction vessel 110 and can be removed when required (not shown).

The reaction between the sugar 118 and the concentrated sulphuric acid 120 is exothermic. The heat generated by the reaction is removed by the heat exchange medium 112. The heat removed from the heat exchange medium 112 is transferred to the water 114. This causes the water 114 to evaporate to produce steam, which is used to drive the turbine 116.

### EXAMPLE 1

Taking common sugar (sucrose) as an example the following basic chemical reaction occurs:

C₁₂H₂₂0₁₁+H₂SO₄=>H₂SO₄+11H₂O+12C=1144 Kj of Heat

One mole of sulphuric acid reduces one mole of sucrose to 12 moles of carbon and 11 moles of water with the evolution of 1144 Kj of heat. The 11 Moles of water will absorb 447.7 kJ heat of evaporation on conversion from boiling water to steam. This leaves 696 kJ of excess heat which can be used for heating purposes.

### EXAMPLE 2

96% sulphuric acid (1562 g) was charged to a glass beaker. Small aliquots of castor sugar were added to the acid with continuous stirring over 3 to 4 hours. The total amount of sugar added was 250 g. The temperature of the reaction mixture increased from about 15 degrees C. to 65 degrees C.

A black solid carbon precipitate was produced in the reaction. This was filtered off using a Buchner funnel. The precipitate was found to contain residual amounts of acid.

### EXAMPLE 3

Example 2 was repeated using 77% sulphuric acid. The reaction was exothermic.

1. A method of heat generation comprising reacting carbohydrate with a concentrated acid in a reaction vessel in an exothermic dehydration reaction, and removing the heat generated by the reaction through a heat exchange medium.

2. A method as claimed in claim 1, which is a substantially continuous method of heat generation.

3. A method as claimed in claim 1, wherein the concentrated acid is concentrated sulphuric acid.

4. A method as claimed in claim 1, wherein the carbohydrate is sugar.

5. A method as claimed in claim 1, wherein the heat exchange medium is liquid.

6. A method as claimed in claim 1, wherein the heat exchange medium is an oil based liquid that is inert to the concentrated acid.

7. A method as claimed in claim 1, wherein the reaction vessel is provided with a heat exchange jacket and wherein any heat is removed from the reaction by the heat exchange medium flowing through the jacket.

8. A method as claimed in claim 1, wherein the heat exchange medium is used as a heating fluid or to heat a heating fluid for a heat exchanger.

9. A method as claimed in claim 1, which comprises transferring energy from the heat exchange medium to a fluid for driving a prime mover and, optionally, driving the prime mover.

10. A method as claimed in claim 1, wherein the carbohydrate is added to the concentrated acid.

11. A method as claimed in claim 10, wherein the carbohydrate is added substantially continuously to the concentrated acid.

12. A method as claimed in claim 1, wherein the concentrated acid is sulphuric acid and wherein the sulphuric acid concentration is at least 70%.

13. A method as claimed in claim 1, wherein water produced in the reaction is removed as steam.

14. A method as claimed in claim 13, wherein the steam is used to drive a prime mover.

15. A method as claimed in claim 1, wherein the concentrated acid is preheated to a temperature of 100 to 105 degrees C. before it is reacted with the carbohydrate.

16. A method as claimed in claim 1, which comprises removing carbon produced as a result of the reaction between carbohydrate and the concentrated acid from the reaction vessel.

17. A method as claimed in claim 16, wherein the acid is sulphuric acid and any residual sulphuric acid removed with the carbon is separated from the carbon by subjecting the carbon to a reduction in pressure sufficient to cause the sulphuric acid to decompose to sulphur oxides and water.

18. A method as claimed in claim 17, wherein the sulphur oxides are reacted with water to form sulphuric acid, optionally in the presence of a catalyst.

19. A method as claimed in claim 18, wherein the sulphuric acid produced is reacted with carbohydrate in the reaction vessel.

20. A method as claimed in claim 17, wherein the sulphur oxides and water are reacted with iodine.

21. An apparatus for carrying out the method claimed in claim 1, said apparatus comprising a reaction vessel for the reaction between concentrated acid and carbohydrate, an inlet for introducing carbohydrate into the reaction vessel, and an outlet for removal of any carbon produced in the reaction from the reaction vessel.

22. An apparatus as claimed in claim 21, wherein the inlet for introducing carbohydrate into the reaction vessel is adapted for introducing carbohydrate into the reaction vessel substantially continuously.

23. The apparatus of claim 21 further comprising a circulator for circulating a heat exchange medium around the said reaction vessel.
